(19) United States
(12) Patent Application Publication
(10) Pub. No.: US 2026/0279916 A1
(43) Pub. Date: Sep. 17, 2026

(54) METHOD OF MANUFACTURING ALL-SOLID-STATE BATTERY

(71) Applicant: HONDA MOTOR CO., LTD., Tokyo (JP)

(72) Inventor: Takashi TOYOSHIMA, Saitama (JP)

(21) Appl. No.: 19/550,275

(22) Filed: Feb. 26, 2026

(30) Foreign Application Priority Data
Mar. 12, 2025 (JP) 2025-039268

(51) Int. Cl. H01M 10/0585; H01M 4/40; H01M 50/474; H01M 4/02; H01M 10/0525

(52) U.S. Cl. CPC H01M 10/0585; H01M 4/405; H01M 50/474; H01M 2004/027; H01M 10/0525

(57) ABSTRACT

Provided is a method of manufacturing an all-solid-state battery including an oxygen removal step of removing oxygen existing in an interior of an intermediate layer or in an interior of the intermediate layer in a laminate including the intermediate layer, and a bonding step of bonding a surface of the intermediate layer from which oxygen existing in the inside is removed or a surface of the laminate including the intermediate layer, from which oxygen existing in the interior of the intermediate layer is removed, on a side on which the intermediate layer is disposed, to a surface of a negative electrode on a side on which a lithium metal layer or a lithium alloy layer is disposed, in a state in which the surface of the intermediate layer is disposed to face the surface of the negative electrode.

This application is based on and claims the benefit of priority from Japanese Patent Application No. 2025-039268, filed on 12 Mar. 2025, the content of which is incorporated herein by reference.

### BACKGROUND OF THE INVENTION

### Field of the Invention

The present invention relates to a method of manufacturing an all-solid-state battery.

### Related Art

In recent years, research and development has been carried out on secondary batteries that contribute to energy efficiency in order for more people to be able to ensure access to energy that is reasonable, reliable, sustainable, and advanced.

PCT International Publication No. WO2023/189892 discloses a solid-state secondary battery that includes a positive electrode layer, a negative electrode layer including a lithium metal layer, a solid electrolyte layer, and an intermediate layer provided between the negative electrode layer and the solid electrolyte layer. Here, the intermediate layer has a porosity larger than a porosity of the solid electrolyte layer. In addition, PCT International Publication No. WO2023/189892 discloses, as a method of manufacturing the solid-state secondary battery, a method of laminating the positive electrode layer, the solid electrolyte layer, the intermediate layer, and the negative electrode layer, and then pressing to integrate the layers.

Patent Document 1: PCT International Publication No. WO2023/189892

### SUMMARY OF THE INVENTION

However, when the solid-state secondary battery disclosed in PCT International Publication No. WO2023/189892 is manufactured, oxygen contained in the intermediate layer may cause oxidation of lithium constituting the lithium metal layer. This inhibits transfer of electrons or lithium ions during the formation of the solid-state secondary battery, resulting in an increase in resistance and a reduction in yield.

The present invention has an object to provide a method of manufacturing an all-solid-state battery capable of allowing oxidation of lithium constituting a lithium metal layer to be reduced.
(1) A method of manufacturing an all-solid-state battery including an electrode laminate in which a negative electrode including a lithium metal layer or a lithium alloy layer, an intermediate layer that has a porosity of 40% or more and 70% or less, a solid electrolyte layer, and a positive electrode are laminated sequentially is provided. The method includes: an oxygen removal step of removing oxygen existing in an interior of the intermediate layer or in an interior of the intermediate layer in a laminate including the intermediate layer, and a bonding step of bonding a surface of the intermediate layer from which oxygen existing in the inside is removed or a surface of the laminate including the intermediate layer, from which oxygen existing in the interior of the intermediate layer is removed, on a side on which the intermediate layer is disposed, to a surface of the negative electrode on a side on which the lithium metal layer or the lithium alloy layer is disposed, in a state in which the surface of the intermediate layer is disposed to face the surface of the negative electrode.
(2) The method of manufacturing an all-solid-state battery as described in (1) further includes a pressing step of pressing a material constituting the intermediate layer or a laminate including the material constituting the intermediate layer to obtain the intermediate layer or the laminate including the intermediate layer, in which a pressing pressure in the pressing step is 300 MPa or more and 1000 MPa or less.
(3) In the method of manufacturing an all-solid-state battery as described in (1), a porosity of the intermediate layer is 40% or more and 45% or less.
(4) The method of manufacturing an all-solid-state battery as described in (3) further includes a pressing step of pressing a material constituting the intermediate layer or a laminate including the material constituting the intermediate layer to obtain the intermediate layer or a laminate including the intermediate layer, in which a pressing pressure in the pressing step is 800 MPa or more and 1000 MPa or less.
(5) The method of manufacturing an all-solid-state battery as described in any one of (1) to (4) includes a pressing step of obtaining an intermediate layer-solid electrolyte layer-positive electrode laminate in which the intermediate layer, the solid electrolyte layer, and the positive electrode are laminated sequentially, an oxygen removal step of removing oxygen existing an interior of the intermediate layer included in the intermediate layer-solid electrolyte layer-positive electrode laminate, and a bonding step of bonding a surface of the intermediate layer-solid electrolyte layer-positive electrode laminate on a side on which the intermediate layer, from which oxygen existing in the inside is removed, is disposed to a surface of the negative electrode on a side on which the lithium metal layer or the lithium alloy layer is disposed, in a state in which the surface of the intermediate layer is disposed to face the surface of the negative electrode, to obtain the electrode laminate.
(6) The method of manufacturing an all-solid-state battery as described in (5) further includes a laminating step of disposing a solid electrolyte constituting the solid electrolyte layer on the positive electrode to obtain a solid electrolyte-positive electrode laminate, and a pressing step of pressing a material constituting the intermediate layer against a surface of the solid electrolyte-positive electrode laminate on a side on which the solid electrolyte is disposed, in a state in which the material is disposed on the surface, to obtain the intermediate layer-solid electrolyte layer-positive electrode laminate.
(7) In the method of manufacturing an all-solid-state battery as described in any one of (1) to (6), the intermediate layer includes a metal and amorphous carbon.

According to an embodiment of the present invention, it is possible to provide a method of manufacturing a solid-state battery capable of allowing oxidation of lithium constituting a lithium metal layer to be reduced.

### BRIEF DESCRIPTION OF THE DRAWINGS

FIG. 1 is a cross-sectional view illustrating an all-solid-state battery according to one embodiment of the present invention;

FIG. 2 is a cross-sectional view for describing a method of manufacturing a positive electrode;

FIG. 3 is a cross-sectional view for describing a method of producing a solid electrolyte-positive electrode laminate;

FIG. 4 is a cross-sectional view for describing a method of manufacturing an intermediate layer-solid electrolyte layer-positive electrode laminate;

FIG. 5 is a cross-sectional view for describing a method of manufacturing an electrode laminate;

FIG. 6 is oxygen element mapping of a cross-sectional SEM image of an all-solid-state lithium metal battery of Example 1; and

FIG. 7 is oxygen element mapping of a cross-sectional SEM image of an all-solid-state lithium metal battery of Comparative Example 1.

### DETAILED DESCRIPTION OF THE INVENTION

An embodiment of the present invention will be described below with reference to the accompanying drawings.

### All-Solid-State Battery

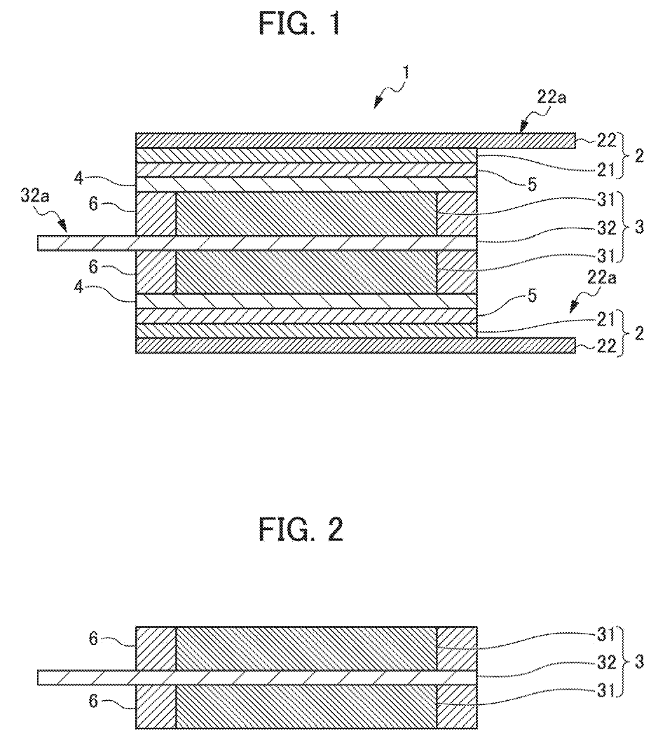

FIG. 1 illustrates an all-solid-state battery according to one embodiment of the present invention.

An all-solid-state battery 1 includes an electrode laminate in which a negative electrode 2, an intermediate layer 5, a solid electrolyte layer 4, a positive electrode 3, a solid electrolyte layer 4, an intermediate layer 5, and a negative electrode 2 are laminated sequentially. In the negative electrode 2, a lithium metal layer 21 and a negative electrode current collector 22 are laminated sequentially in a laminating direction of the electrode laminate. Here, a negative electrode current collector tab 22a extends from one end of the negative electrode current collector 22.

In the positive electrode 3, a positive electrode mixture layer 31, a positive electrode current collector 32, and a positive electrode mixture layer 31 are laminated sequentially in a laminating direction of the electrode laminate. When the positive electrode 3 is viewed from above with respect to the laminating direction of the electrode laminate, an outer peripheral portion of the positive electrode mixture layer 31 in inside an outer peripheral portion of the positive electrode current collector 32, and an insulating frame 6 is provided on the outer peripheral portion of the positive electrode mixture layer 31. At this time, when the insulating frame 6 is viewed from above with respect to the laminating direction of the electrode laminate, an outer peripheral portion of the insulating frame 6 is at approximately the same position as the outer peripheral portion of the positive electrode current collector 32. Here, a positive electrode current collector tab 32a extends from an end portion of the positive electrode current collector 32 on an opposite side to the end portion from which the negative electrode current collector tab 22a extends.

A porosity of the intermediate layer 5 is 40% or more and 70% or less, and preferably 40% or more and 45% or less. When the porosity of the intermediate layer 5 is 40% or more and 70% or less, lithium metal is deposited uniformly during charging of the all-solid-state battery 1. In addition, the interface bondability with the solid electrolyte layer 4 having a low porosity is enhanced. A thickness of the intermediate layer 5 is, but is not particularly limited to, for example, 2 µm or more and 10 µm or less.

A porosity of the solid electrolyte layer 4 is, but is not particularly limited to, for example, 1% or more and 7% or less. A thickness of the solid electrolyte layer 4, but is not particularly limited to, for example, 3 µm or more and 50 µm or less.

Note that the all-solid-state battery 1 is not particularly limited as long as it includes an electrode laminate in which a negative electrode 2, an intermediate layer 5, a solid electrolyte layer 4, and a positive electrode 3 are laminated sequentially. For example, the all-solid-state battery 1 may include multiple positive electrode 3. Alternatively, the all-solid-state battery 1 may include a single negative electrode 2, a single intermediate layer 5, and a single solid electrolyte layer 4. In this case, the positive electrode 3 has a positive electrode mixture layer 31 and a positive electrode current collector 32, which are laminated sequentially in the laminating direction of the electrode laminate.

### Method of Manufacturing All-Solid-State Battery

Next, a method of manufacturing the all-solid-state battery 1 will be described with reference to FIGS. 2 to 5.

### Positive Electrode

A positive electrode mixture constituting the positive electrode mixture layer 31 and an insulating material constituting the insulating frame 6 are disposed on each surface of the positive electrode current collector 32 to obtain the positive electrode 3 (see FIG. 2). A method of disposing the positive electrode mixture includes, but is not particularly limited to, for example, a method of transferring the positive electrode mixture using a positive electrode mixture layer transfer sheet. The positive electrode mixture layer transfer sheet is obtained, for example, by applying a support sheet with a slurry obtained by dispersing the positive electrode mixture in a solvent, and then drying the slurry. A method of disposing the insulating material includes, but is not particularly limited to, for example, a method of transferring the insulating material using an insulating layer transfer sheet. The insulating layer transfer sheet is obtained, for example, by applying a support sheet with a slurry obtained by dispersing the insulating material in a solvent, and then drying the slurry.

### Laminating Step

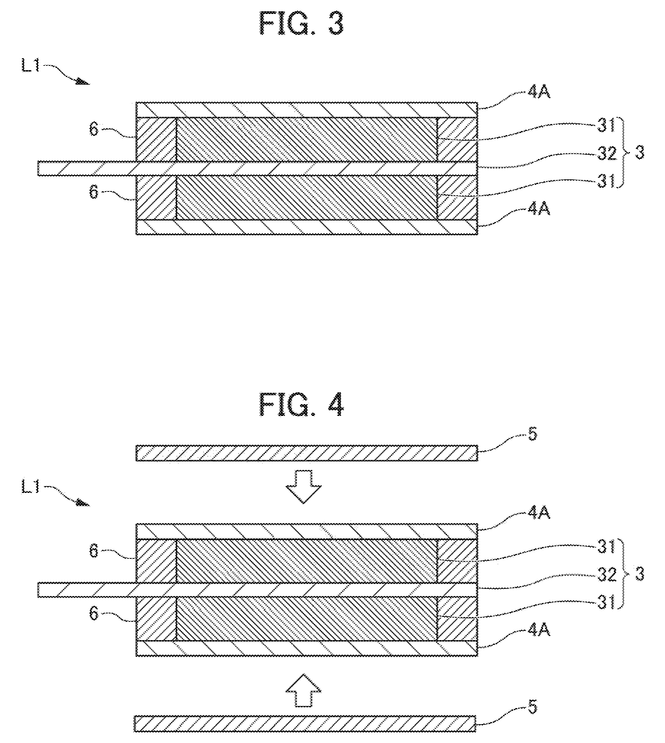

A material constituting the solid electrolyte layer 4, that is, a solid electrolyte 4A is disposed on surfaces of the positive electrode 3 on each side on which the positive electrode mixture layer 31 and the insulating frame 6 are disposed, to obtain a solid electrolyte-positive electrode laminate L1 (see FIG. 3). A method of disposing the solid electrolyte 4A includes, but is not particularly limited to, for example, a method of applying a slurry obtained by dispersing the solid electrolyte 4A in a solvent, and then drying the slurry.

### Intermediate Layer Transfer Sheet

A material constituting the intermediate layer 5 is disposed on a support sheet to obtain an intermediate transfer sheet. A method of disposing a material constituting the intermediate layer 5 includes, but is not particularly limited to, for example, a method of applying a slurry obtained by dispersing the material constituting the intermediate layer 5 in a solvent, and then drying the slurry.

### Press Step

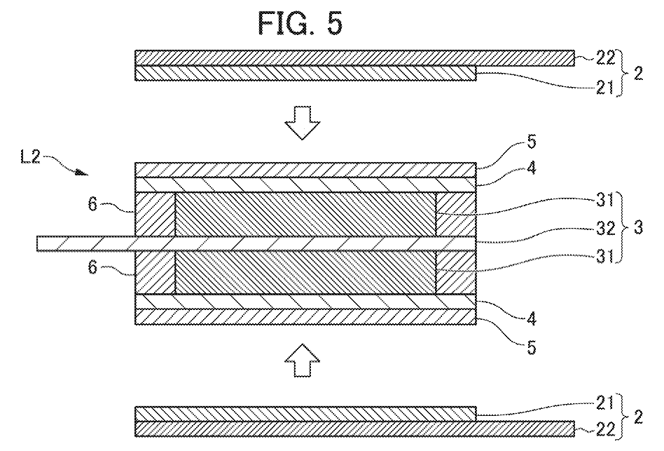

A material constituting the intermediate layer 5 is pressed against surfaces of the solid electrolyte-positive electrode laminate L1 on each side on which the solid electrolyte 4A is disposed using the intermediate layer transfer sheet, in a state in which the material is disposed on the surfaces, to obtain an intermediate layer-solid electrolyte layer-positive electrode laminate L2 (see FIGS. 4 and 5). At this time, a pressing pressure is preferably 300 MPa or more and 1000 MPa or less so that the porosity of the intermediate layer 5 is 40% or more and 70% or less. In addition, the pressing pressure is preferably 800 MPa or more and 1000 MPa or less so that the porosity of the intermediate layer 5 included in the electrode laminate is 40% or more and 45% or less. A pressing temperature is, but is not particularly limited to, for example, 25°C or more and 120°C or less.

Note that the method of manufacturing the intermediate layer-solid electrolyte layer-positive electrode laminate L2 is not particularly limited as long as the intermediate layer 5, the solid electrolyte layer 4, and the positive electrode 3 can be laminated sequentially.

For example, instead of the solid electrolyte-positive electrode laminate, a solid electrolyte layer-positive electrode laminate may be obtained by pressing the solid electrolyte 4A against surfaces of the positive electrode 3 on each side on which the positive electrode mixture layer 31 and the insulating frame 6 are disposed, in a state in which the solid electrolyte 4A is disposed on the surfaces. A method of disposing the solid electrolyte 4A includes, but is not particularly limited to, a method of transferring the solid electrolyte 4A using a solid electrolyte transfer sheet, for example. The solid electrolyte layer transfer sheet is included, for example, a method of applying a support sheet with a slurry obtained by dispersing the solid electrolyte 4A in a solvent, and then drying the slurry. At this time, a pressing pressure and a pressing temperature are the same as those when the intermediate layer-solid electrolyte layer-positive electrode laminate L2 is obtained.

In this case, the intermediate layer-solid electrolyte layer-positive electrode laminate L2 can be obtained by pressing the material constituting the intermediate layer 5 against surfaces of the solid electrolyte layer-positive electrode laminate on each side on which the solid electrolyte layer 4 is disposed, in a state in which the material is disposed on the surfaces. A method of disposing the material constituting the intermediate layer 5 is the same as that when the intermediate layer transfer sheet is obtained.

### Oxygen Removal Step

Oxygen is removed which exists in an interior of the intermediate layer 5 included in the intermediate layer-solid electrolyte layer-positive electrode laminate L2. Therefore, oxidation of lithium constituting the lithium metal layer 21 can be reduced even when the intermediate layer 5 is in contact with the lithium metal layer 21 when the electrode laminate is obtained. As a result, variations in performance of the all-solid-state battery 1 are reduced without inhibiting transfer of electrons or lithium ions during the formation of the all-solid-state battery 1. At this time, an oxygen concentration in gas that exists in the interior of the intermediate layer 5 from which the oxygen is removed is, but is not particularly limited to, for example, 0% by volume or more and 10% by volume or less. A method of removing oxygen existing in the interior of the intermediate layer 5 includes, but is not particularly limited to, for example, a method of storing the intermediate layer-solid electrolyte layer-positive electrode laminate L2 under a vacuum environment to remove oxygen existing in the interior of the intermediate layer 5, and a method of storing the intermediate layer-solid electrolyte layer-positive electrode laminate L2 under an inert gas atmosphere to replace oxygen existing in an interior of the intermediate layer 5 with inert gas, and two or more kinds thereof may be used in combination. The inert gas is not particularly limited as long as is can reduce oxidation of lithium, and may be, for example, argon gas or nitrogen gas.

### Bonding Step

The surface of the negative electrode 2 on the side on which the lithium metal layer 21 is disposed is bonded to surfaces of the intermediate layer-solid electrolyte layer-positive electrode laminate L2 on each side on which the intermediate layer 5, from which oxygen existing in the inside thereof is removed, is disposed, in a state in which these surfaces are disposed facing each other, to obtain an electrode laminate (see FIG. 5).

A machine used to manufacture the all-solid-state battery 1 includes, but is not particularly limited to, for example, a roll press machine, and a flat plate press machine.

### Modified Example

Instead of oxygen existing in the interior of the intermediate layer 5 included in the intermediate layer-solid electrolyte layer-positive electrode laminate L2, oxygen existing in the interior of the intermediate layer 5 may be removed. In this case, the intermediate layer 5 from which oxygen existing in the inside thereof is removed is bonded to a surface of the negative electrode 2 on a side on which the lithium metal layer 21 is disposed, in a state in which the intermediate layer 5 is disposed to face the surface, to obtain a negative electrode-intermediate layer laminate. Next, for example, a surface of the negative electrode-intermediate layer laminate on a side on which the intermediate layer 5 is disposed is bonded to surfaces of the solid electrolyte-positive electrode laminate L1 on each side on which the solid electrolyte 4A is disposed, in a state in which the surface of the intermediate layer 5 is disposed on the surfaces of the solid electrolyte 4A, to obtain an electrode laminate.

Instead of oxygen existing in the interior of the intermediate layer 5 included in the intermediate layer-solid electrolyte layer-positive electrode laminate L2, oxygen existing in the interior of the intermediate layer 5 included in an intermediate layer-solid electrolyte layer laminate may be removed. In this case, a surface of the intermediate layer-solid electrolyte layer laminate on a side on which the intermediate layer 5, from which oxygen existing in the inside thereof is removed, is disposed is bonded to a surface of the negative electrode 2 on a side on which the lithium metal layer 21 is disposed, in a state in which these surfaces are disposed to face each other, to obtain a negative electrode-intermediate layer-solid electrolyte layer laminate. Next, for example, a surface of the negative electrode-intermediate layer-solid electrolyte layer laminate on a side on which the solid electrolyte 4A is disposed is bonded to surfaces of the positive electrode 3 on each side on which the positive electrode mixture layer 31 and the insulating frame 6 are disposed, in a state in which the surface of the negative electrode-intermediate layer-solid electrolyte layer laminate is disposed on the surfaces of the positive electrode 3.

In the all-solid-state battery 1, instead of the lithium metal layer 21, a lithium alloy layer may be used. An element other than lithium constituting the lithium alloy layer includes, but is not particularly limited to, for example, Sn, Ag, Mg, In, Si, and Al.

The negative electrode current collector 22 includes, but is not particularly limited to, for example, a copper foil.

The positive electrode mixture layer 31 includes a positive electrode active material, and may further include a solid electrolyte, a conductivity aid, a binding agent, and the like. The positive electrode active material is not particularly limited as long as it can absorb and release lithium ions, and may be, for example, lithium nickel cobalt manganese composite oxide. The solid electrolyte is not particularly limited as long as it has lithium-ion conductivity, and may be, for example, an oxide-based electrolyte or a sulfide-based electrolyte. The conductivity aid is not particularly limited as long as it has electron conductivity, and may be, for example, carbon black. The binding agent is not particularly limited as long as it can improve binding properties, and may be, for example, styrene butadiene rubber.

The positive electrode current collector 32 includes, but is not particularly limited to, for example, an aluminum foil.

The solid electrolyte 4A is not particularly limited as long as it has lithium-ion conductivity, and may be for example, an inorganic solid electrolyte such as an oxide-based electrolyte or a sulfide-based electrolyte.

The intermediate layer 5, which has the function of depositing lithium metal uniformly, stabilizes the interface between the intermediate layer 5 and the solid electrolyte layer 4. The intermediate layer 5 includes a metal and amorphous carbon, and may further include a binding agent. The metal and amorphous carbon are preferably nanoparticles.

The metal is not particularly limited as long as it can be alloyed with lithium, and may be, for example, tin (Sn), silicon (Si), zinc (Zn), magnesium (Mg), gold (Au), platinum (Pt), palladium (Pd), silver (Ag), aluminum (Al), bismuth (Bi), or antimony (Sb).

The amorphous carbon may be, but is not particularly limited to, for example, carbon blacks such as acetylene black, furnace black, and Ketjen black, coke, or activated carbon. The amorphous carbon may be graphitizable carbon (soft carbon), non-graphitizable carbon (hard carbon), carbon nanotubes (CNTs), fullerenes, or graphene.

The binding agent may be, but is not particularly limited to, for example, polyvinylidene fluoride (PVDF).

The material constituting the insulating frame 6 may be, but is not particularly limited to, for example, an insulating oxide such as alumina, a resin such as polyvinylidene fluoride (PVDF), or a rubber such as styrene butadiene rubber (SBR).

Although an embodiment of the present invention has been described above, the present invention is not limited to the above-described embodiment, and the above-described embodiment may be modified as appropriate within the scope of the present invention. For example, the all-solid-state battery 1 may further include an exterior housing body (for example, a laminating film) that encloses the electrode laminate.

### EXAMPLES

Although an example of the present invention will be described below, the present invention is not limited to the example.

### Example 1

### Positive Electrode

A positive electrode mixture was dispersed in a solvent to obtain a slurry. Next, a support sheet was applied with the slurry, and then the slurry was dried to obtain a positive electrode mixture layer transfer sheet.

An insulating material was dispersed in a solvent to obtain a slurry. Next, a support sheet was applied with the slurry, and then the slurry was dried to obtain an insulating layer transfer sheet.

A positive electrode mixture layer and an insulating frame were formed by transferring the positive electrode mixture and the insulating material to each surface of a positive electrode current collector using the positive electrode mixture layer transfer sheet and the insulating layer transfer sheet to obtain a positive electrode.

(See FIG. 2).

### Laminating Step

A solid electrolyte was dispersed in a solvent to obtain a slurry. The method includes a method of applying the slurry and then drying it. Next, a solid electrolyte was formed by applying each surface of the positive electrode with the slurry, and then drying the slurry to obtain a solid electrolyte-positive electrode laminate (see FIG. 3).

### Intermediate Layer Transfer Sheet

A metal and amorphous carbon were dispersed in a solvent to obtain a slurry. Next, the slurry was applied on a support sheet, and then dried to obtain an intermediate layer transfer sheet.

### Pressing Step

The metal and amorphous carbon were transferred to each surface of the solid electrolyte-positive electrode laminate using the intermediate layer transfer sheet, and then were pressed at a pressing pressure of 800 MPa using a roll press machine to obtain an intermediate layer-solid electrolyte layer-positive electrode laminate (see FIGS. 4 and 5). At this time, the intermediate layer had a porosity of 42%.

### Oxygen Removal Step

The intermediate layer-solid electrolyte layer-positive electrode laminate was stored under a vacuum environment to remove oxygen existing in an interior of the intermediate layer.

### Bonding Step

A lithium metal negative electrode was bonded to a surface of the intermediate layer-solid electrolyte layer-positive electrode laminate on a side on which the intermediate layer, from which oxygen existing in the inside thereof is removed, is disposed to obtain an all-solid-state lithium metal battery.

### Comparative Example 1

An all-solid-state lithium metal battery was obtained as in Example 1 except that the (Oxygen Removal Step) was omitted.

### Oxygen Element Distribution of Intermediate Layer

An oxygen element distribution of the intermediate layer of the all-solid-state lithium metal battery was evaluated by the SEM-EDS.

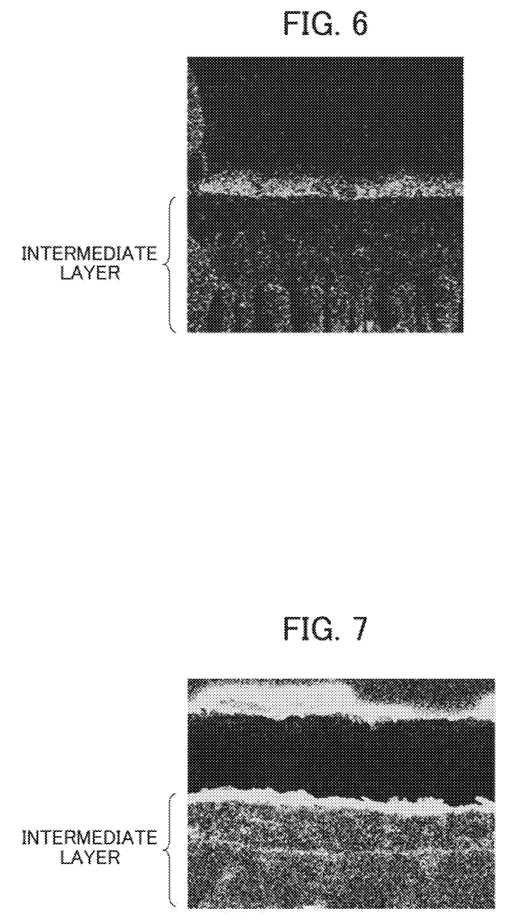

FIGS. 6 and 7 show oxygen element mapping of cross-sectional SEM images of the all-solid-state lithium metal batteries of Example 1 and Comparative Example 1, respectively.

From FIGS. 6 and 7, it is found that the all-solid-state lithium metal battery of Example 1 has an oxygen amount in the intermediate layer that is smaller than an oxygen amount in the all-solid-state lithium metal battery of Comparative Example 1. Therefore, it is assumed that the all-solid-state lithium metal battery of Example 1 allows oxidation of lithium constituting the lithium metal negative electrode to be reduced.

### EXPLANATION OF REFERENCE NUMERALS

1 All-solid-state battery

2 Negative electrode

21 Lithium metal layer

22 Negative electrode current collector

22a Negative electrode current collector tab

3 Positive electrode

31 Positive electrode mixture layer

32 Positive electrode current collector

32a Positive electrode current collector tab

4 Solid electrolyte layer

4A Solid electrolyte

5 Intermediate layer

6 Insulating frame

L1 Solid electrolyte-positive electrode laminate

L2 Intermediate layer-solid electrolyte layer-positive electrode laminate

What is claimed is:

1. A method of manufacturing an all-solid-state battery including an electrode laminate in which a negative electrode including a lithium metal layer or a lithium alloy layer, an intermediate layer that has a porosity of 40% or more and 70% or less, a solid electrolyte layer, and a positive electrode are laminated sequentially, the method comprising:
an oxygen removal step of removing oxygen existing in an interior of the intermediate layer or in an interior of the intermediate layer in a laminate including the intermediate layer; and
a bonding step of bonding a surface of the intermediate layer from which oxygen existing in the inside is removed or a surface of the laminate including the intermediate layer, from which oxygen existing in the interior of the intermediate layer is removed, on a side on which the intermediate layer is disposed, to a surface of the negative electrode on a side on which the lithium metal layer or the lithium alloy layer is disposed, in a state in which the surface of the intermediate layer is disposed to face the surface of the negative electrode.

2. The method of manufacturing an all-solid-state battery according to claim 1, further comprising:
a pressing step of pressing a material constituting the intermediate layer or a laminate including the material constituting the intermediate layer to obtain the intermediate layer or the laminate including the intermediate layer,
wherein a pressing pressure in the pressing step is 300 MPa or more and 1000 MPa or less.

3. The method of manufacturing an all-solid-state battery according to claim 1, wherein
a porosity of the intermediate layer is 40% or more and 45% or less.

4. The method of manufacturing an all-solid-state battery according to claim 3, further comprising:
a pressing step of pressing a material constituting the intermediate layer or a laminate including the material constituting the intermediate layer to obtain the intermediate layer or a laminate including the intermediate layer,
wherein a pressing pressure in the pressing step is 800 MPa or more and 1000 MPa or less.

5. The method of manufacturing an all-solid-state battery according to claim 1, comprising:
a pressing step of obtaining an intermediate layer-solid electrolyte layer-positive electrode laminate in which the intermediate layer, the solid electrolyte layer, and the positive electrode are laminated sequentially;
an oxygen removal step of removing oxygen existing an interior of the intermediate layer included in the intermediate layer-solid electrolyte layer-positive electrode laminate; and
a bonding step of bonding a surface of the intermediate layer-solid electrolyte layer-positive electrode laminate on a side on which the intermediate layer, from which oxygen existing in the inside is removed, is disposed to a surface of the negative electrode on a side on which the lithium metal layer or the lithium alloy layer is disposed, in a state in which the surface of the intermediate layer is disposed to face the surface of the negative electrode, to obtain the electrode laminate.

6. The method of manufacturing an all-solid-state battery according to claim 5, further comprising:
a laminating step of disposing a solid electrolyte constituting the solid electrolyte layer on the positive electrode to obtain a solid electrolyte-positive electrode laminate; and
a pressing step of pressing a material constituting the intermediate layer against a surface of the solid electrolyte-positive electrode laminate on a side on which the solid electrolyte is disposed, in a state in which the material is disposed on the surface to obtain the intermediate layer-solid electrolyte layer-positive electrode laminate.

7. The method of manufacturing an all-solid-state battery according to claim 1, wherein
the intermediate layer includes a metal and amorphous carbon.
